(19) United States
(12) Patent Application Publication
(10) Pub. No.: US 2002/0097488 A1
(43) Pub. Date: Jul. 25, 2002

(54) Safety apparatus for microscopes having a laser beam as illumination source

(75) Inventors: William C. Hay, Heppenheim (DE); Heinrich Ulrich, Heidelberg (DE)

Correspondence Address: FOLEY AND LARDNER, SUITE 500, 3000 K STREET NW, WASHINGTON, DC, 20007, US

(73) Assignee: Leica Microsystems Heidelberg GmbH

(21) Appl. No.: 10/042,163

(22) Filed: Jan. 11, 2002

(30) Foreign Application Priority Data
Jan. 25, 2001 (DE) 101 03 256.0

(51) Int. Cl. G02B 21/00; G02B 21/06

(52) U.S. Cl. 359/385; 359/368

(57) ABSTRACT

A microscope possesses at least one illumination source for emitting electromagnetic radiation, an objective holder, and a detector. Also provided is a detection device which is configured so that it detects whether an element is inserted in the objective holder. The detection device is coupled to a blocking device for interrupting the electromagnetic radiation.

### CROSS REFERENCE TO RELATED APPLICATIONS

This invention claims priority of the German patent application 101 03 256.0 which is incorporated by reference herein.

### FIELD OF THE INVENTION

The invention concerns a microscope and a scanning microscope.

### BACKGROUND OF THE INVENTION

In scanning microscopy, a specimen is illuminated with a light beam in order to observe the reflected or fluorescent light emitted from the specimen, laser beams usually being used for illumination. The general construction of a scanning microscope is described in the textbook by James B. Pawley, “Handbook of Biological Confocal Microscopy,” 1990, 1989 Plenum Press, New York. On pages 4 through 7, for example, the principle of confocal microscopy is described (see FIG. 2 in Pawley). A specimen is scanned with a finely focused light beam; the light emitted from the specimen passes via a beam splitter to a detector that comprises an entrance pinhole.

In confocal scanning microscopy specifically, a specimen is scanned in three dimensions with the focus of a light beam. A confocal scanning microscope generally comprises a light source, a focusing optical system with which the light of the source is focused onto a pinhole (called the “excitation stop”), a beam splitter, a scanning apparatus for beam control, a microscope optical system, a detection stop, and the detectors for detecting the detected or fluorescent light. The illuminating light is coupled in via a main beam splitter. The fluorescent or reflecting light coming from the specimen arrives via the same scanning mirrors back at the main beam splitter and passes through it, and is then focused onto the detection stop behind which the detectors (usually photomultipliers) are located. Detected light that does not derive directly from the focus region takes a different light path and does not pass through the detection stop, so that what is obtained is a point datum which results, by sequential scanning of the specimen, in a three-dimensional image. A three-dimensional image is usually obtained by acquiring image data in layers.

Lasers are often used in microscopy for manipulation of small specimen regions. For example, specimen regions can be cut out or displaced, or specimen constituents can be sorted or picked out. A method of this kind is known from EP 0 879 408 B1, among others.

As is known from DE 32 02 461 C1, objectives that are housed in an objective holder are used in optical microscopes. So-called revolving nosepieces, in which are provided a plurality of objective holding positions into each of which an objective can be inserted, are usually used in this context. Each time the revolving nosepiece is rotated, a different objective holding position with a different objective can be moved into the beam path. With the aid of a bayonet attachment and a centering taper, it is possible to insert an objective in defined fashion into each of the objective holding positions. Because it is now possible to insert the objectives in accurately positioned fashion, technical data provided on the objective can be picked off. These can be sensed by a reading device attached to the microscope, and can be used to control device functions such as stops, display devices, etc.

With the lasers usually used as illumination sources in microscopes and scanning microscopes, the specimen can be optimally illuminated or manipulated in order to achieve the desired result. The lasers used in this context can, however, constitute a hazard to the user of the microscope (i.e. the operator) if the necessary safety regulations are not followed. These regulations are intended, in particular, to prevent laser light from passing in uncontrolled fashion into the operator's eye, this being associated with a health hazard to the eyesight in particular. U.S. Pat. No. 5,850,038 has therefore already proposed a scanning microscope that is equipped with an additional observation eyepiece for observing the specimen support stage. To prevent laser light from entering the observation eyepiece while the user is using the eyepiece, a shutter device which must be opened when the eyepiece is used, and whose open or closed position is sensed and forwarded to a microcomputer, is provided. The microcomputer is in turn connected to a unit that switches off the laser source whenever the eyepiece opening is open, and switches on the laser source when the eyepiece opening is closed. This ensures that when the eyepiece is being utilized by the user of the microscope, no laser light can get into the eyepiece. This device has the disadvantage, however, that when the specimen plate is observed without the eyepiece, laser light can nevertheless get into the user's eye, especially if scattered light is produced, for example, because an objective is not inserted.

### SUMMARY OF THE INVENTION

It is therefore the object of the present invention further to reduce the hazards associated with operation of a microscope or of a scanning microscope.

According to the present invention, this object is achieved by a microscope comprising at least one illuminating light source for emitting an electromagnetic radiation, an objective holder for holding an element, a detection device for detecting whether an element is inserted in the objective holder, a blocking device for interrupting the electromagnetic radiation, whereby the blocking device is coupled to the detection device.

The purpose of the invention is achieved fundamentally by the provision of a detection device which is capable of sensing whether or not an element, in particular an objective or a so-called dummy element, is inserted into an objective mount. The detection device is directly or indirectly connected to a blocking device, the blocking device interrupting the laser radiation when the detection device senses that no element is inserted into the objective mount. The element introduced into the objective mount can be an objective or a so-called dummy element, the dummy element closing off the objective holder in the event that an objective does not need to be inserted. The combination of detection device and blocking device just described can be used in scanning microscopes as a safety apparatus, resulting in the particular advantage for the user of the microscope that the scanning microscope is always switched off when no element is inserted in an objective mount. This also eliminates the risk that scattered light, which might result in damage to the user's eye, might be created by the absence of an element in an objective mount.

In a particularly preferred embodiment of the invention, the microscope is equipped with a revolving nosepiece that comprises a plurality of objective holding positions, into each of which an objective can be inserted. When the microscope is in operation, according to safety regulations an objective or a dummy element must be inserted into each of the objective holding positions. In this embodiment, the combination according to the present invention of a detection device and blocking device is preferably embodied in such a way that a detection device is provided for each of the objective holding positions, and the blocking device interrupts the laser beam as soon as an element is not inserted in at least one of the objective holding positions.

As an alternative thereto, the combination of detection device and blocking device can be embodied in such a way that the interruption of the laser beam occurs only when an objective holding position of the revolving nosepiece into which no element is inserted is rotated into the beam path. This embodiment has the advantage that the microscope can be operated even if not all the objective holding positions are occupied by an element; the safety of the user is nevertheless ensured, since the laser beam is always interrupted when the beam might pass freely through an objective holding position.

### BRIEF DESCRIPTION OF THE DRAWINGS

Further advantages and advantageous embodiments of the invention are evident from the Figures below and their description, correctly scaled reproduction in the Figures having been dispensed with in the interest of clarity.

Specifically:

FIG. 1 shows the general configuration of a scanning microscope;

FIG. 2 shows the schematic configuration of a scanning microscope having a detection and blocking device according to the present invention;

FIG. 3 shows a portion of the schematic construction of a scanning microscope with a detection device according to the present invention;

FIG. 4 is a schematic depiction of a revolving nosepiece of a scanning microscope, in a plan view.

### DETAILED DESCRIPTION OF THE INVENTION

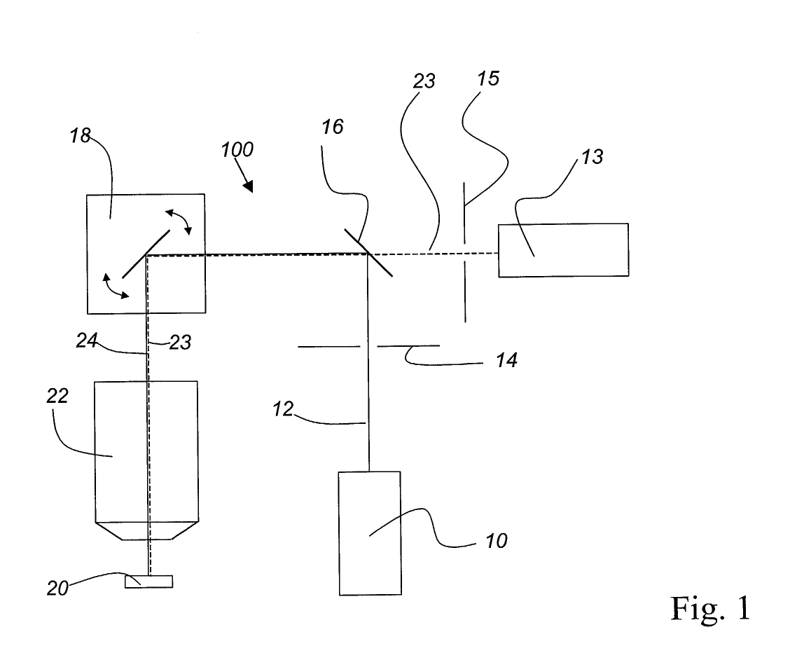

FIG. 1 shows the general configuration of a scanning microscope. Said configuration substantially comprises a light source 10 that generates an illuminating light beam 12. Via an illumination stop 14, illuminating light beam 12 arrives at a main beam splitter 16. From main beam splitter 16, the light of light source 10 arrives at a scanner 18. Scanner 18 is configured in such a way that with it, a specimen 20 being examined is scanned in a desired fashion by a scanning light beam 24. Scanning light beam 24 passes via an objective 22 to specimen 20 being examined. In the same fashion, a detected light beam 23 sent back from specimen 20 is imaged by objective 22 onto scanner 18. Proceeding from scanner 18, detected light beam 23 passes through main beam splitter 16. A detection stop 15 is provided in front of a detector 13 arranged after main beam splitter 16 in detected light beam 23.

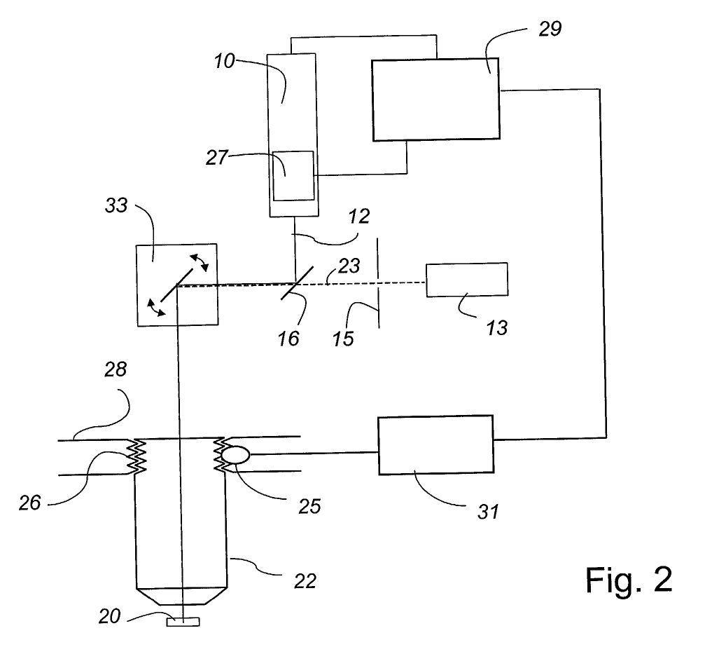

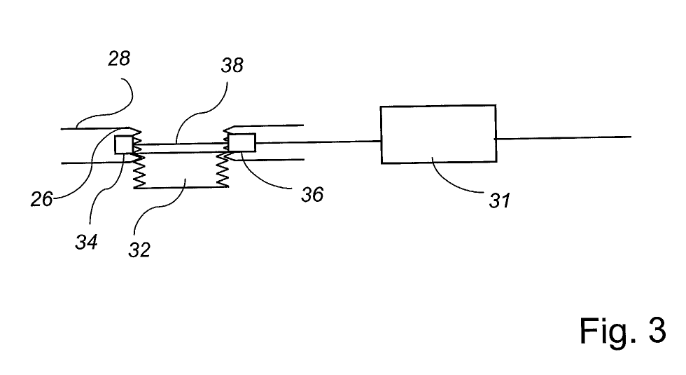

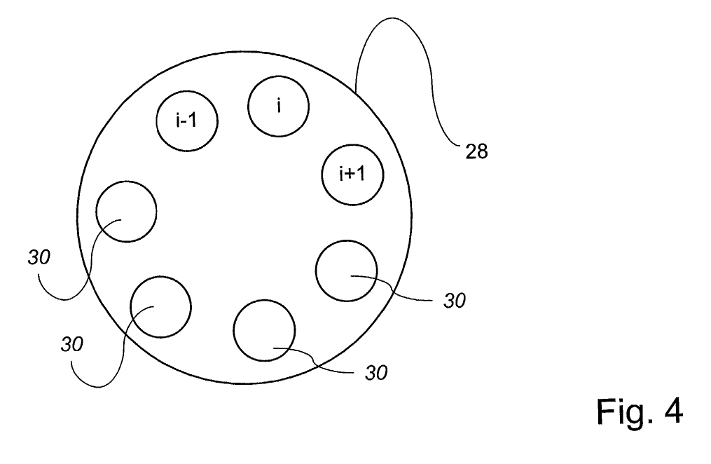

As shown in FIG. 2, objective 22 is mounted in an objective holder 26, for example threaded in or attached by means of a bayonet fastener. A so-called revolving nosepiece 28, which comprises a plurality of objective holding positions 30 (FIG. 4) each with one objective holder 26, is usually provided in this context. In order to guarantee that during operation of the microscope, an illuminating light beam 12 is emitted only when an objective 22 or a dummy element 32 (FIG. 3) is inserted into objective holder 26, a detection device 25 is used to check whether an objective 22 or dummy element 32 (FIG. 3) is inserted into objective holder 26. If an objective holding position 30 is not to be used, it must be closed off during operation of the microscope with a so-called dummy element, so that detection device 25 is also capable of detecting whether a dummy element is inserted into objective holder 26. Detection device 25 is embodied in the present case as a microswitch. As an objective 22 is inserted, in particular threaded, into the objective holder, microswitch 25 is actuated, thereby e.g. closing an electrical contact and consequently closing or interrupting an electrical circuit. The actuation of microswitch 25 thus generates a signal which serves as an indication that an objective 22 is inserted into objective holder 26. That signal is forwarded to a blocking device 27. Blocking device 27 is embodied in such a way that it ensures that an illumination is interrupted, i.e. an illuminating light beam 12 is interrupted or not generated at all, when detection device 25 recognizes that an element is not inserted into objective holder 26.

According to the embodiment shown in FIG. 2, detection device 25 is connected via a so-called interlock 31 to power supply component 29 of laser 10. Power supply component 29 is in turn connected to blocking device 27, for example a shutter; and the shutter is closed whenever detection device 25 does not detect an element in objective holder 26. The result is to prevent an illuminating light beam 12 from emerging from laser 10 in this state. The shutter can be configured, for example, as a blade that drops into the beam path, inside or outside the resonator of laser 10, when the laser beam is to be interrupted.

In addition to the use of microswitches as detection devices 25, it is of course also possible to use other suitable elements as detection devices. Particularly appropriate in this context are other mechanical or magnetic contact elements, for example magnetic proximity switches, with which the insertion of an objective 22 into objective holder 26 can be detected. It is also possible, in similar fashion, to detect whether a dummy element 32 (shown in FIG. 3) is inserted into objective holder 26.

As shown in FIG. 3, it is furthermore possible to use as the detection device an electromagnetic transmission and reception system, in particular an optical light barrier system. In this context a light source, for example a photodiode 34, that emits a light beam 38 is used in objective holder 26. Said light beam 38 can be sensed by a light detector 36 located opposite. As long as light detector 36 is sensing light beam 38, a dummy element 32 is not inserted into objective holder 26. In such a case a signal is, for example, in turn forwarded via interlock 31 to blocking device 27 in order to interrupt irradiation of the specimen. Only when light detector 34 no longer detects light beam 38 is the signal to enable specimen illumination forwarded to blocking device 27.

It is clear that the electromagnetic light barrier having light source 34 and light detector 36 together with objective 22 or dummy element 32 can also be configured in such a way that light beam 38 from light source 34 arrives at light detector 36 only when objective 22 or dummy element 32 is inserted. For that purpose, the objectives 22 and dummy elements 32 that are used must be equipped with corresponding light guides or orifices. The embodiment just described, in particular, has the further advantage of also making it possible to ascertain whether an element has been inserted correctly and in accurately positioned fashion into objective holder 26.

Blocking device 27 shown in FIG. 2 is embodied as a shutter element inside laser 10, and blocks out the laser beam whenever an element is not inserted into the objective holder. Of course it is also possible to provide other blocking devices which are used to prevent an illuminating light beam 12 from being directed toward specimen 20. In addition to the blocking out of a beam inside or outside laser 10, it is also possible for the laser itself to be switched off; for example, power supply component 29 is switched off so that a laser beam is not produced.

FIG. 4 schematically shows a revolving nosepiece 28 having a plurality of objective holding positions 30, each of objective holding positions 30 comprising an objective holder into which an objective 22 or a dummy element 32 is to be inserted when the microscope is intended to be operated. In a further embodiment of the invention, the detection device can be provided in such a way that each of objective holding positions 30 that is provided is monitored as to whether or not an element is inserted. If even only one of objective holding positions 30 has no element inserted into it, the detection device forwards to blocking device 27 a signal which then causes laser beam 12 to be interrupted.

According to a further embodiment of the invention, only a single objective holding position i in revolving nosepiece 28 is observed. Objective holding position i is located in the beam path of scanning light beam 24, which here extends perpendicular to the paper plane through position i. This in turn ensures that the microscope can be operated only when an element, i.e. an objective 22 or a dummy element 32, is inserted in the beam path of scanning light beam 24. This embodiment of the invention can be realized in two different ways. On the one hand, a detection device 36, 25 can be provided in each objective holder 26 (FIG. 2) of objective holding positions 30, but it is activated only when the respective objective holding position 30 is rotated into position i. External contact elements that activate the detection device upon rotation of an objective holding position 30 into position i can be provided, for example, for this purpose. On the other hand, this embodiment of the invention can also be realized by the fact that detection device 36, 25 is provided externally, i.e. outside revolving nosepiece 28. One simple possibility for embodying detection device 25 in this fashion consists, for example, in configuring the detection device as a light barrier which is then, however, mounted outside revolving nosepiece 28 and shines through objective holding position i. If the light barrier is interrupted upon rotation of an objective holding position 30 from position i−1 into position i, the detection device generates a signal which indicates that an element is inserted into the objective holder. If the light barrier remains uninterrupted after the rotation of objective holding position 30 into position i, there is no element inserted into objective holder 26 and specimen illumination beam 12 is correspondingly interrupted.

Although the invention has been described with reference to several particular embodiments, it is self-evident that changes and modifications can be made without thereby leaving the range of protection of the claims recited hereinafter.

What is claimed is:

1. A microscope comprising:
at least one illuminating light source for emitting an electromagnetic radiation, an objective holder for holding an element, a detection device for detecting whether an element is inserted in the objective holder, a blocking device for interrupting the electromagnetic radiation, whereby the blocking device is coupled to the detection device.

2. The microscope according to claim 1, wherein the blocking device is configured so that it can switch off the illumination source.

3. The microscope according to claim 1, wherein the blocking device is configured so that it can effect a blocking out of the electromagnetic radiation proceeding from the illumination source.

4. The microscope according to claim 1, wherein the detection device consists essentially of a mechanical obstruction, an optical obstruction, a magnetic obstruction or an electrical obstruction.

5. The microscope according to claim 1, wherein the detection device is interrupted when an element is inserted.

6. The microscope according to claim 1, wherein the detection device is closed when an element is inserted.

7. The microscope according to claim 1, wherein the objective holder is a revolving nosepiece having multiple objective holding positions.

8. The microscope according to claim 7, wherein the electromagnetic radiation is interrupted when at least one of the objective holding positions has no element.

9. The microscope according to claim 7, wherein the electromagnetic radiation is interrupted when the objective holding position located in the beam path of the electromagnetic radiation has no element.

10. The microscope according to claim 1, wherein the element is an objective or a dummy element.

11. The microscope according to claim 1, further comprising an apparatus for laser microdissection.

12. A scanning microscope comprising:
at least one illuminating light source for emitting an electromagnetic radiation, an objective holder for holding an element, a detection device for detecting whether an element is inserted in the objective holder, a blocking device for interrupting the electromagnetic radiation, whereby the blocking device is coupled to the detection device.

13. The microscope according to claim 12, wherein the blocking device is configured so that it can switch off the illumination source.

14. The scanning microscope according to claim 12, wherein the blocking device is configured so that it can effect a blocking out of the electromagnetic radiation proceeding from the illumination source.

15. The scanning microscope according to claim 12, wherein the objective holder is a revolving nosepiece having multiple objective holding positions.

16. The scanning microscope according to claim 15, wherein the electromagnetic radiation is interrupted when at least one of the objective holding positions has no element.

17. The microscope according to claim 15, wherein the electromagnetic radiation is interrupted when the objective holding position located in the beam path of the electromagnetic radiation has no element.
